(19) United States
(12) Patent Application Publication
(10) Pub. No.: US 2006/0256927 A1
(43) Pub. Date: Nov. 16, 2006

(54) Portable x-ray film cassette safety device and placement process with or without inflation device

(76) Inventor: Eric John Meittunen, Rochester, MN (US)

Correspondence Address: Warren Alexander Reiter, 150 North Clark Street, Forest City, IA, 50436, US

(21) Appl. No.: 11/128,917

(22) Filed: May 12, 2005

(51) Int. Cl. G03B 42/04

(52) U.S. Cl. 378/182

(57) ABSTRACT

A device and a method that allows an X-ray technician to easily lift a patient and place an X-ray film with or without a grid under the patient for the taking of an X-ray with a portable X-ray machine. The device includes a notches that allow the technician to properly align the patient and the X-ray film prior to the taking of the X-ray. The device also includes a tube and an inflation device to lift the patient so the X-ray film maybe properly placed under the patient. The present invention also includes a method by which the device is to be used when taking a portable X-ray.

### FEDERALLY SPONSORED RESEARCH

Not Applicable

### SEQUENCE LISTING OR PROGRAM

Not Applicable

### BACKGROUND—FIELD OF INVENTION

This invention is a device and process to be used with a portable x-ray cassette and/or x-ray cassette with a grid.

According to the National Safety Council, 3.7 million American workers suffered disabling injuries on the job in the year 2002. Work-related injuries cost Americans $146.6 billion in 2002, amounting to $1,060 per worker. A survey conducted by the Bureau of Labor Statistics (BLS) indicated a total of 4.7 million nonfatal injuries and illnesses were reported in private industry in 2002. Further evaluation of the data provided by the BLS indicates that the services industry, of which healthcare is a part, led the percent of nonfatal injuries by industry division with 27.3% of the injuries.

A more in-depth breakdown of the nonfatal injuries and illnesses within the services industry shows health services—Standard Industrial Classification (SIC) code 80—as the primary contributor, with more than 623,000 recordable cases. Hospitals (SIC code 806) lead the total number of cases and incidence rates of nonfatal occupational injuries and illnesses for industries with more than 100,000 reported cases with over 321,000 cases and an incidence rate of 9.7. Nursing homes are third.

For nursing aides and orderlies, patient care activities were identified as the most frequent cause of injuries. Literature supports the musculoskeletal risks, exposures, and injuries that were identified by the BLS. In particular, back injuries were identified as a leading injury associated with healthcare incidents.

In 1990, Jensen identified the specific criteria that led to the risk of injury and then defined the health outcome associated with this type of exposure. The study utilized Meta analysis (incidents after accomplishing the patient transfer tasks) to determine that a larger number of injuries occurred among patient care personnel who frequently performed physically strenuous patient handling. An additional study concluded that the variety and number of risk factors for those involved in offering patient care were directly correlated with the frequency of patient transfers.

The portable radiograph (x-ray) is included in this category (patient care activities) as the tasks required to place and position the cassette beneath the patient offer similar risk factors as a typical patient transfer.

The portable radiograph (x-ray) is used primarily for chest and abdomen x-rays. The portable radiograph (x-ray) is needed if a patient is too ill to be transferred to an area with standard radiology equipment in the healthcare facility, thus the radiology equipment and cassette is brought to the patient room in order to accomplish the radiograph. Depending on the desired result of the x-ray, a grid may be used in the process to enhance the radiograph image. The grid is a box shaped container that the portable x-ray film cassette fits inside of. Typically the location for the portable x-ray to be accomplished is in the patient room; however the x-ray may be accomplished in other locations as well. Radiology Technician staff accomplish several thousand portable x-rays each day in healthcare facilities.

The portable x-ray offers an increase in acute and chronic musculoskeletal exposure and thus the potential injury to staff for those that are involved in the task. The primary cause of injury for the task is related to the forces that are required to position the portable x-ray cassette beneath or behind the patient. The typical forces involve pushing the cassette under the patient while lifting the patient with the other hand. The lift component creates a gap between the patient and the surface in which they are lying or sitting on in order to facilitate placement of the cassette. Presently these movements or variability of the steps required to position the x-ray cassette offers a force that is significant and thus creates the potential for injury to the staff involved with the portable radiology (x-ray) process.

The radiology safety placement device and placement process reduces the forces required to place the radiology x-ray cassette and/or placement of a radiology x-ray cassette with a grid under or behind the patient. The result of the force reduction required to place the cassette with the device and process is a decrease in the potential for musculoskeletal injuries for radiology technician staff while providing for an increase patient comfort during the portable radiograph (x-ray) process.

### BACKGROUND—DESCRIPTION OF PRIOR ART

Numerous devices have been developed which assist the X-ray technician with properly positioning a patient prior to and during the taking of an X-ray. These prior devices are extremely useful in situations where the patient is mobile and can be placed on a specialized table or X-ray equipment. This device allows an X-ray of immobilized patient via a portable X-ray machine without undue stress on the patient and reducing the likelihood of injury to the technician.

Patents to Johnson, U.S. Pat. No. 5,243,639; Cook III, U.S. Pat. No. 4,893,323; and Wright, U.S. Pat. No. 5,703,925; all are some sort of a combination Portable X-ray table and stretcher. These devices have several limitations such as the patient must already be on these devices rather than a normal hospital bed or require the technician or medical staff to lift the patient onto these devices thus exposing the hospital staff to potential injuries.

Other patents describe methods and devices to move disable patients such as Patents to Garman U.S. Pat. No. 5,651,149; Robert U.S. Pat. No. 6,728,979; and Votel U.S. Pat. No. 6,772,456. These devices are extremely complicated and expose the patient to a great deal of stress. Further, these devices are designed to move the patient to allow a X-ray to be taken. The current invention is design to allow the patient remain in their bed while a portable X-ray machine is brought to them.

U.S. Pat. No. 5,992,416 describes a device that is used to properly align the patient when a portable X-ray machine is used to take an X-ray. This device has several limitation in that does not include a means for place the X-ray film and a mechanical means to lift a heavier patient like the device described in this invention.

While the last prior art device considered above describes a device used to align a patient with use with a portable X-ray machine, which is the part of the subject of the present invention. The apparatus and method employed by the present invention depart from the conventional concepts and designs taught by the prior art. In doing so, the present invention provides a method and device to not only align the patient for taking an X-ray but to provide means to lift and place a film and grid under the patient, as well. It accomplishes the result in a different and improved manner.

### SUMMARY OF THE INVENTION

The preferred embodiment of the radiology safety placement device and its method of use of the present invention solves the problems encountered in the present state of art in a simple and straightforward manner. What is provided is a device that allows a placement of an x-ray film under both heavy and lighter patients. When this device is used in combination with the method described in the current invention the x-ray film can be placed with minimal strain of the technician therefore reducing the risk of injury to the technician.

The device consists of two panels that have handles to allow the technician to slide the panels under the patient and the x-ray film with one hand. The panels further have a notch to allow for proper alignment of the x-ray film. The device is further equipped with a device to allow for inflation. The inflation is necessary if the patient is heavier.

It is an object of the present invention to provide a device that allows for taking of an x-ray of a patient that is unable to be moved to an x-ray machine and a portable x-ray machine is required to take such an x-ray.

In order to accomplish these objective the device allows the placement of x-ray with or without the inflation of the device but with minimal movement of the patient and strain on the technician.

Further, the present invention provides a method to use the device of the present invention with or without inflation of the device. The method describes how to use the device of the present invention with or without inflation of the device to obtain the overall objectives of the present invention to take an x-ray of immobile patient without the need of complicated machines and without undue strain on the technicians.

### BRIEF DESCRIPTION OF THE DRAWINGS

For a further understanding of the nature and objects of the present invention, reference should be had to the following detailed description, taken in conjunction with the accompanying drawings, in which like parts are given like reference numerals and, wherein:

FIG. 1 Radwedge Device with X-Ray Film Cassette.

FIG. 2 Radwedge Device with Assist Inflation and X-Ray Film Cassette.

FIG. 3 Flow Chart of How to Use the Radwedge Device Prior to Deciding Whether Inflation Assistance is Needed.

FIG. 4 Flow Chart of How to Place the X-ray Film With or Without a Grid and With or Without Use of Inflation Assistance in the Radwedge Device

FIG. 5 Flow Chart of Taking the X-ray and the Removal of the X-ray from the Radwedge Device.

### DETAILED DESCRIPTION OF THE PREFERRED EMBODIMENT

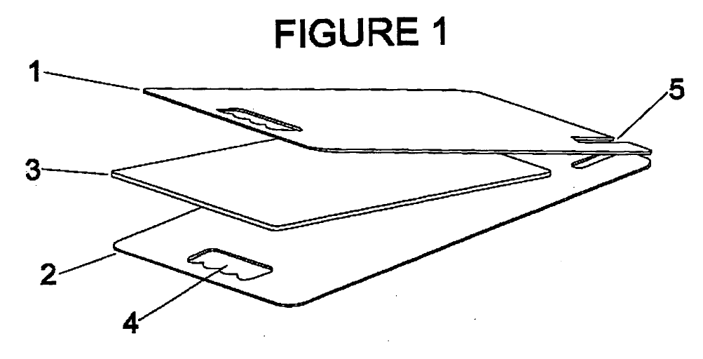

The portable x-ray safety placement device shown in FIG. 1 consists of two parts, a top panel (1) and a bottom panel (2). FIG. 1 also shows a portable x-ray film, cassette and/or grid (3). The top and bottom panels (1) and (2) are approximately flat with a basic smooth interior. The top and bottom panels (1, 2) also have a smooth edge parameter so that the device does not harm or cut the patient during use. The top and bottom panels (1) and (2) are made of a semi-rigid yet flexible translucent material that allows for ease of placement (sliding) under or behind a patient.

The top and bottom panels has a handle openings (4) that allows a technician to grasp the panels either separately and/or together. The top and bottom panels (1,2) when held together with the handles (4) allow for both the panels to be slid beneath or behind the patient in a uniform manner to prepare for the insertion of the portable radiograph x-ray cassette film with or without grid (3). The panels also have a notch cut out (5) in order to allow the user to have access to the portable radiograph x-ray cassette film with or without grid (3) during positioning in-between the panels and while under or behind the patient. This notch cut out provides for a tactile verification of the proper portable x-ray cassette film with or without grid during placement under or behind the patient.

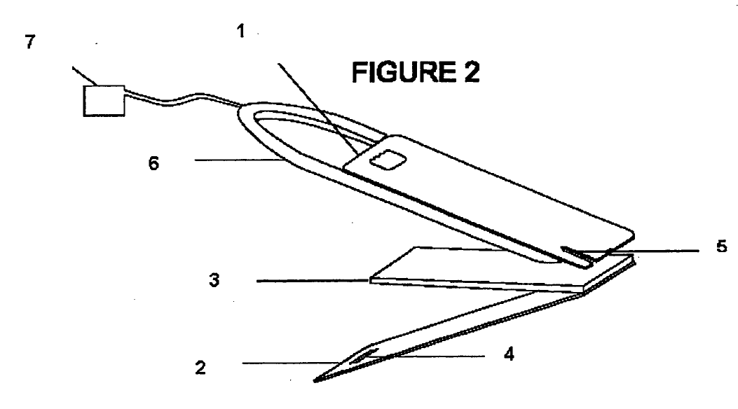

FIG. 2 shows the portable x-ray safety placement device with top panel (1), bottom panel (2), x-ray film, cassette and/or grid (3), notch cut out (5), and handles (4). The device also shows inflatable tubes (6), and an inflation source supply that is attached to the inflatable tubes (7). The inflatable tubes (6) are attached to the supply source (8) via a connection clamp that inserts a fluid and/or air to inflate the tubes that are located about the interior parameter of the top and bottom panels (1, 2).

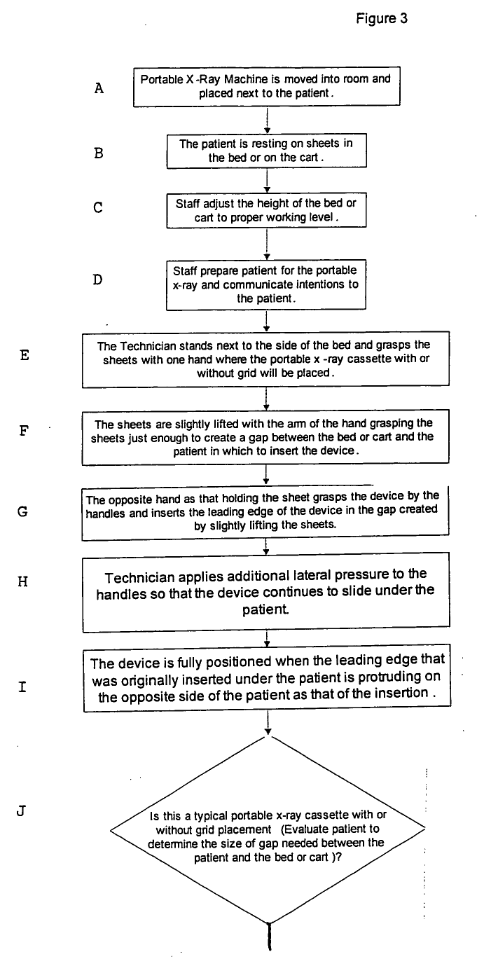

FIG. 3 shows a process to use the portable x-ray safety placement device noted in FIGS. 1 and 2 during a portable radiograph x-ray process. The process facilitates the placement of a portable radiograph x-ray cassette film with or without grid under or behind a patient by the technician. The process enhances the safety for the technician by reducing the forces involved in the process in addition to improving the comfort level for the patient.

The technician moves the portable x-ray machine is moved into the room next to the patient (FIG. 3-A) who is lying or resting on sheets in a bed or a cart (FIG. 3-B). The height of the bed or cart is adjusted to the proper working level (FIG. 3-C). The portable x-ray and patient are prepared and the process is communicated to the patient (FIG. 3-D).

The process of placing the portable x-ray safety placement device (FIGS. 1 and 2) begins as the technician grasps the sheet from under the patient with one hand (FIG. 3-E) and provides a minimum of force to lift the sheet and create an opening (gap) between the patient and the bed (FIG. 3-F). The technician uses the opposing hand to grasps the radiology placement safety device (FIGS. 1 and 2) by the handles (FIG. 1-4) and inserts the leading edge of the device in the gap between the patient and the bed (FIG. 3-G). The placement of the radiology placement safety device resumes as the technician applies additional lateral pressure to the handles so that the device continues to slides under the patient (FIG. 3-H). The device is fully positioned when the leading edge that was originally inserted under the patient is protruding on the opposite side of the patient as that of the insertion (FIG. 3-I).

The technician must decide whether or not it is a typical portable x-ray cassette placement with or without a grid (FIG. 3-J). This is done by the technician evaluating the patient and determining the gap needed between the patient and the bed or cart (FIG. 3-J).

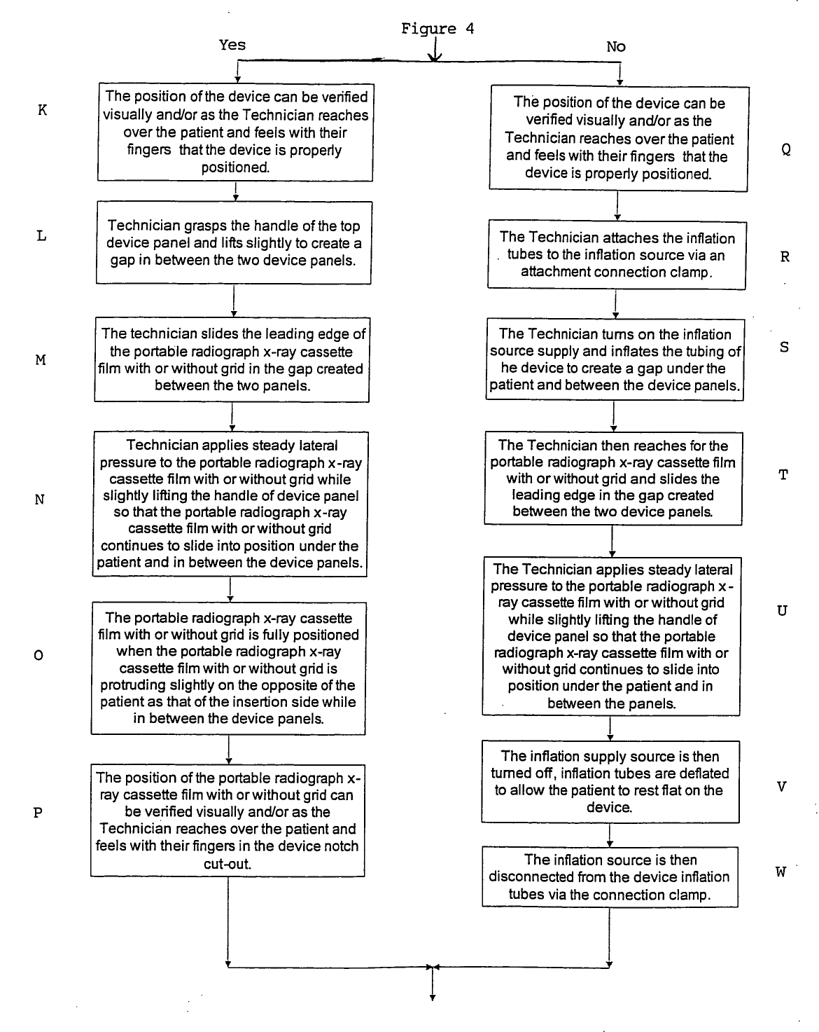

If a typical placement is determined to be appropriate then the technician proceeds without the assistance of an inflation device (FIG. 4-K). However, if untypical placement is determined to be appropriate then the technician proceeds with the assistance of an inflation device (FIG. 4-Q to FIG. 4-X).

This position can be verified visually and/or the technician reaches over the patient and feels with their fingers in the notch cut out (FIG. 1-5) that the device is properly positioned (FIG. 4-K). The technician grasps the handle of the top panel (FIG. 1-1) and lifts slightly to create a gap in between the top panel (FIG. 1-1) and the bottom panel (FIG. 1-2), as described in FIG. 4-L. The technician slides in the x-ray cassette film with or without a grid in between the gap between the top and bottom panels (FIG. 4-M). The placement of the radiology placement safety device resumes as the technician applies additional lateral pressure to the handles so that the device continues to slides under the patient (FIG. 4-N). The device is fully positioned when the leading edge that was originally inserted under the patient is protruding on the opposite side of the patient as that of the insertion (FIG. 4-O). The position is again verified visually and/or the technician reaches over the patient and feels with their fingers in the notch cut out (FIG. 1-5) that the device is properly positioned (FIG. 4-P).

If a portable x-ray is to be accomplished for a heavier patient additional forces are required to place the portable radiograph x-ray cassette film with or without grid beneath the patient. Thus the safety of the Technician may be compromised with an increase risk of musculoskeletal injury. In order to reduce the forces involved in the portable x-ray process for larger patients the radiology safety placement device with assist inflation should be used to place beneath the portable radiograph x-ray cassette film with or without grid and accomplish the portable x-ray. Initial application, placement, and use of the device with the inflatable tube are similar to that of the basic device for placement, positioning, and removal. The inflation tube option allows the user to further expand the gap between the device panels once the inflation tubes are activated. Thus the expanded gap provides for more ease of placement of the portable radiograph x-ray cassette film with or without grid under or behind the patient.

If the technician decides that inflation assistance is needed (FIG. 3-J), the technician process with steps necessary for inflation (FIG. 4-Q to FIG. 4-X). The position is verified visually and/or the technician reaches over the patient and feels with their fingers in the notch cut out (FIG. 1-5) that the device is properly positioned (FIG. 4-Q).

To accomplish the operation of the device for the heavier patient the technician attaches the inflation tubes that are located on the interior parameter of the device to the inflation source via an attachment connection clamp (FIG. 4-R). The technician then turns on the inflation source supply and inflates the tubing located on the interior parameter of the device thus creating a gap under the patient and between the device panels (FIG. 4-S). As the tubes about the interior parameter of the device are inflated to create for a larger opening the technician grasps the handle of the top device panel (1) and lifts slightly to create a gap in between the two device panels (1 and 2). This gap that is created is a key component and when combined with the slick surface of the radiology safety placement device offers a safer method to position the portable radiograph x-ray cassette film with or without grid under the patient by reducing the friction forces required in the positioning process. The technician then reaches for the portable radiograph x-ray cassette film with or without grid and slides the leading edge in the gap created between the two panels (FIG. 4-T). The technician applies steady lateral pressure to the portable radiograph x-ray cassette film with or without grid while slightly lifting the handle of device panel (1) so that the portable radiograph x-ray cassette film with or without grid continues to slide into position under the patient and in between the panels. The portable radiograph x-ray cassette film with or without grid is fully positioned when the device is protruding slightly on the opposite of the patient as that of the insertion side. This portable radiograph x-ray cassette film with or without grid position can be verified visually and/or as the Technician reaches over the patient and feels with their fingers in the notch cut out (5) that the device is properly positioned (FIG. 4-U). The inflation supply source is then turned off by the Technician and inflation tubes are deflated to allow the patient to rest flat on the device without the increased opening needed for placement of the portable radiograph x-ray cassette film with or without grid (FIG. 4-V). The inflation source is then disconnected from the device inflation tubes via the connection clamp (FIG. 4-X). If the portable radiograph x-ray cassette film with or without grid is not positioned in the desired location under the patient for the portable x-ray properly post deflation, then the Technician micro positions the portable radiograph x-ray cassette film with or without grid while under the patient and between the device panels, rechecks the notch cut out to verify the desired location of the portable radiograph x-ray cassette film with or without grid.

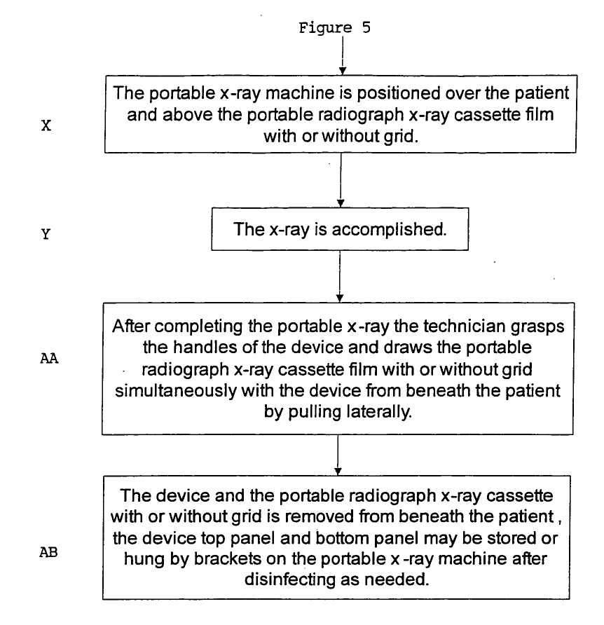

The technician positions the portable x-ray machine above the patient and the portable radiograph x-ray cassette film with or without grid (FIG. 5-Y). The technician then takes the x-ray of the patient (FIG. 5-Z).

After completing the portable x-ray, the technician grasps the handles of the device and draws the portable radiograph x-ray cassette film with or without grid from beneath the patient by pulling laterally. The portable radiograph x-ray cassette film with or without grid is removed simultaneously with the device (FIG. 5-AA).

Once the device and the portable radiograph x-ray cassette film with or without grid ?6? is removed from beneath the patient the device top panel (FIG. 1-1 and bottom panel FIG. 1-2) may be stored or hung by brackets on the portable x-ray machine after disinfecting as needed (FIG. 5-AB).

The above described process has several advantages over the currently used technology. This two step placement process (radiology safety placement device and then the portable radiograph x-ray cassette film with or without grid) beneath the patient facilitates the technician to set up the portable x-ray by reducing the forces required in the process when compared to other present methods used today. The two step process also reduces the potential for mattress material and sheet tearing that occurs with typical presently used processes. In addition the two step process provides for an increase in patient safety and comfort by reducing the opportunities for skin tears and bruising. Further, presently lead characters are taped to the portable radiograph x-ray cassette film with or without grid in order to show a patient identification or reference number on the x-ray film. In the typical methods used to withdraw the portable radiograph x-ray cassette film with or without grid at present the characters can become lodged under the patient during withdrawal and the technician must reach beneath the patient to remove the dislodged characters. This one step withdrawal method (with the radiology safety placement device) also helps to reduce the potential for lost lead characters that are commonly taped to the portable radiograph x-ray cassette film with or without grid in order to assist in the patient identification process.

In the preferred embodiment a plastic material is used however other material maybe used with out departing from the spirit and scope of the present invention. In view of the above detailed description of the present invention and associated drawings, other modifications and variations will now become apparent to those skilled in the art. It should be apparent that such other modifications and variations may be effected without departing from the spirit and scope of the present invention.

What is claimed is:

1. A Radwedge device for the placement of an X-ray film under a patient on any bed which has a top and bottom panels that are basically flat and smooth and the leading edge is smooth;
these panels have handle openings at the opposite end of the leading edge to allow the technician to easily place the device under the patient;
these panels have a notch on the leading edge side to allow the technician a means to easily decide if the device is properly placed under the patient.

2. A Radwedge device for the lifting or turning or holding a patient or a portion of a patient on any bed;
the device has a top and bottom panels that are basically flat and smooth and the leading edge is smooth;
these panels have handle openings at the opposite end of the leading edge to allow the technician to easily place the device under the patient;
these panels have a notch on the leading edge side to allow the technician a means to easily decide if the device is properly placed under the patient;
where an inflation tube an inflating device is used to lift the patient.

3. A Radwedge device in claim 2 for the placement of an X-ray film under a patient.

4. A method for using a Radwedge device for the placement of an X-ray film under a patient on any bed where the technician first prepares and places a portable X-ray machine in the patients room at the appropriate level;
the technician then grasps the sheets with one hand and slightly lifts the patient to create a gap between the patient and the bed/cart;
the technician with the opposite hand grasps the Radwedge device by the handles and inserts the leading edge of Radwedge device in the said gap;
the technician applies lateral pressure to the handles so that the Radwedge device is slide under the patient until the leading edge of the Radwedge device is protruding on the opposite side of the patient;
the technician checks to make sure the device is properly placed by reaching over the patient and feeling for the notch;
the technician decides whether an inflation device is needed or not;
the technician creates a gap between the two panels of the Radwedge device by either grasping the top panel of said device and lifting slightly or uses the inflation tube and inflating device to create said gap;
the technician slides an X-ray film with or without a grid into the gap just created;
the technician again applies lateral pressure via the handles to reposition the Radwedge device;
the technician again checks to make sure the Radwedge device is properly placed by reaching over the patient and feeling for the notch;
the technician positions the portable X-ray machine over the patient;
the technician takes an X-ray;
the technician then grasps the Radwedge device by the handle and pulls said device and the X-ray film simultaneously out from under the patient;
the technician cleans, disinfects, and puts up the Radwedge device.
